(19) United States
(12) Patent Application Publication
(10) Pub. No.: US 2025/0283494 A1
(43) Pub. Date: Sep. 11, 2025

(54) BEND RESTRICTOR CLAMP

(71) Applicant: OneSubsea AS, Oslo (NO)

(72) Inventors: Daniel Persson, Tranby (NO); Tor Erling Ruud, Tranby (NO)

(21) Appl. No.: 19/073,718

(22) Filed: Mar. 7, 2025

(30) Foreign Application Priority Data
Mar. 7, 2024 (NO) 20240220

(51) Int. Cl. F16B 7/04

(52) U.S. Cl. CPC F16B 7/0406

(57) ABSTRACT

A bend restrictor clamp comprising a receiving aperture, a plurality of movable locking elements, and springs biassing the locking elements towards a radially inner position. The respective locking elements comprise an inclined actuation face, enabling automatic latching.

### TECHNICAL FIELD

The present invention relates to a bend restrictor clamp with an automatic latching function.

### BACKGROUND ART

When using high-power electric cables or umbilicals at offshore environments, it is common to use bend restrictors that prevent excessive bending. The bend restrictors are typically assembled with a plurality of joints that are mounted onto the cable or umbilical.

In some situations, one needs to connect one length of a bend restrictor to another. This connection process can sometimes be hazardous, since the components are large and heavy. For instance, if connecting below a suspended umbilical termination assembly (UTA), one wishes to avoid personnel working below it.

The disclosed bend restrictor clamp enables such a connection between bend restrictor parts without the need of manipulating the bend restrictor clamp with direct human contact. In particular, the two bend restrictor parts can be connected simply by moving one bend restrictor part into the bend restrictor clamp.

### SUMMARY OF INVENTION

There is disclosed a bend restrictor clamp comprising a receiving aperture, a plurality of movable locking elements, and springs biassing the locking elements towards a radially inner position. The respective locking elements comprise an inclined actuation face.

The receiving aperture is configured to receive the end of a bend restrictor portion, i.e., the bend restrictor portion to which the bend restrictor clamp shall be connected.

An advantage with using locking elements that are biased and the inclined actuation face, is that the bend restrictor clamp can automatically be clamped to the bend restrictor portion, i.e., without any direct manual manipulation. In this manner, no personnel have to be close to the bend restrictor during connection.

The bend restrictor clamp can further comprise a connection flange at the axial end of the bend restrictor clamp which is opposite the receiving aperture.

The connector flange is configured to connect to a bend restrictor. Hence, the bend restrictor clamp is suited for connecting two bend restrictor portions.

The locking elements can be movably arranged in element channels. The bend restrictor clamp can further have channel lids at the radially outer end of the element channels. This enables assembly of the bend restrictor clamp and will also have additional advantages, as will be discussed further below.

The locking elements can comprise a pin that extends through an aperture in the channel lid. The pin may extend beyond the outer surface of the channel lid when the locking element is in a radially outer position.

In this way, the pins enable the operator to see the movement of the locking elements during the connection procedure.

In some embodiments, the locking elements can further comprise a lock actuation slot. Moreover, the bend restrictor clamp can further comprise locking pins with a tip arranged in engagement with the lock actuation slot.

The locking pins enable locking of the locking elements in their locked position, to prevent accidental unlocking. Moreover, the locking pins enable visual verification to the operator that the locking of the bend restrictor clamp to a bend restrictor has been successful.

Furthermore, in some embodiments, the lock actuation slot can extend parallel to the direction of movement of the locking element and can comprise a rotation-inducing shoulder. The locking pin can be supported in a rotatable manner, which enables rotation about a rotation axis. The tip can be offset from the rotation axis and can be in engagement with the rotation-inducing shoulder. Thus, upon a radially outwards movement of the locking element, the locking pin can be rotated into a rotated position, out of engagement with the rotation-inducing shoulder. It can then move further into the lock actuation slot.

The rotation of the locking pin will give a visual signal to the operator that the locking element has been moved.

The locking pin can advantageously be biased, such as with a spring, against the lock actuation slot, in the direction of the rotation axis. When the locking element is in its radially inner position and when the locking pin is in its rotated position, the tip can be in a locking position, out of the lock actuation slot.

When in the locking position, the locking pin is in a position wherein it has been displaced further towards the locking element along the direction of the rotation axis.

The locking pins can advantageously have an indication element attached to a stem of the locking pin. The indication element can be attached to a support stem of the locking pin.

The indication element makes it easier for the operator to see if the locking pin has rotated and if it has moved into its locking position.

Advantageously, the receiving aperture can be provided with an inclined guide face. This facilitates movement of the bend restrictor portion that shall be connected into the bend restrictor clamp without direct manual manipulation.

The bend restrictor clamp can have a main body that has a first main body part and a second main body part that are joined with a plurality of bolts or by other means.

Thus, the bend restrictor clamp can be attached to a bend restrictor with the connection flange by assembling the first and second main body parts onto it.

### BRIEF DESCRIPTION OF THE DRAWINGS

While various features have been discussed in general terms above, a more detailed and non-limiting example of embodiment will be presented in the following with reference to the drawings, in which:

FIG. 1 to FIG. 3 are perspective views illustrating the process of connecting an upper bend restrictor portion to a bend restrictor clamp;

FIG. 4 is a perspective view of the bend restrictor clamp and the lower end of the upper bend restrictor portion during the connection process;

FIG. 5 is a cross-section sideview of the parts shown in FIG. 4;

FIG. 6 and FIG. 7 are cross-section sideviews corresponding to FIG. 5, illustrating further steps of the connection process;

FIG. 8 is a perspective view of a locking pin;

FIG. 9 is a perspective view illustrating the engagement between a locking pin and a lock actuation slot of a locking element;

FIG. 10 is a schematic cross-section sideview of the engagement shown in FIG. 9;

FIG. 11 to FIG. 14 correspond to FIG. 9 and FIG. 10, illustrating further steps of the connection process; and

FIG. 15 is a schematic view of a locking element and a channel lid.

### DETAILED DESCRIPTION

One or more specific embodiments of the present disclosure will be described below. The particulars shown herein are by way of example, and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Additionally, to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are used in an open-ended fashion, and thus should be interpreted to mean “including, but not limited to.” Also, any use of any form of the terms “connect,” “engage,” “couple,” “attach,” or any other term describing an interaction between elements is intended to mean either an indirect or a direct interaction between the elements described. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. The use of “top,” “bottom,” “above,” “below,” and variations of these terms is made for convenience but does not require any particular orientation of the components.

Certain terms are used throughout the description and claims to refer to particular features or components. As one skilled in the art will appreciate, different persons may refer to the same feature or component by different names. This document does not intend to distinguish between components or features that differ in name but not function.

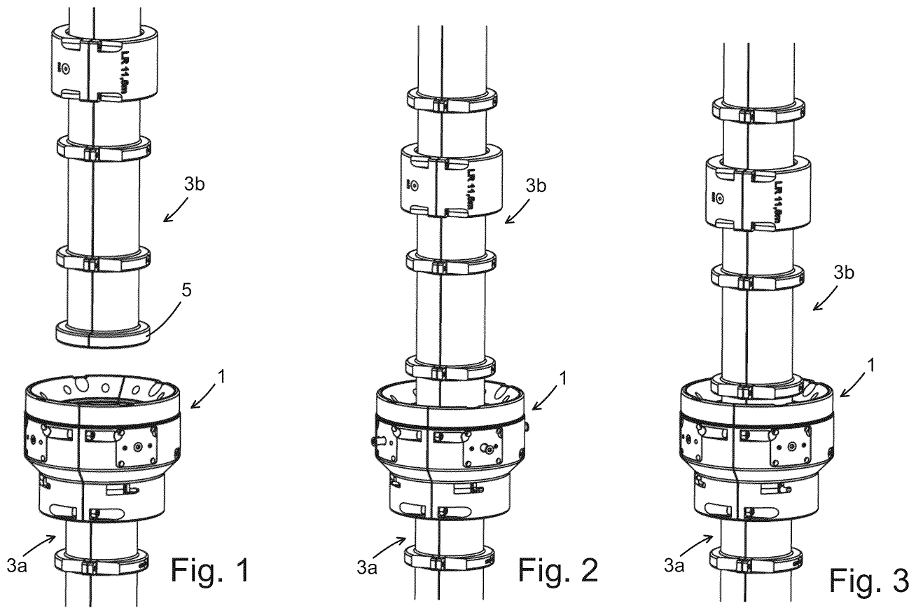

FIG. 1 depicts a bend restrictor clamp 1 attached to a lower bend restrictor portion 3a. Above the bend restrictor clamp 1 there is arranged an upper bend restrictor portion 3b.

The shown situation can typically occur when an umbilical termination assembly (UTA) (not shown) is suspended with the upper bend restrictor portion 3b hanging down from it. The upper bend restrictor portion 3b shall be connected to the lower bend restrictor portion 3a, by means of the bend restrictor clamp 1. The bend restrictor clamp 1 can typically be arranged on the deck, e.g., the moon pool, of an offshore surface structure, such as a vessel (not shown). As the skilled reader will appreciate, the UTA and the umbilical itself are heavy parts, and it is desirable to avoid personnel being present below the UTA.

As the upper bend restrictor portion 3b is lowered down towards and into the bend restrictor clamp 1, it will automatically be latched to the lower bend restrictor portion 3a. This is shown in FIG. 2 and FIG. 3. The function of the bend restrictor clamp 1 will be discussed in the following.

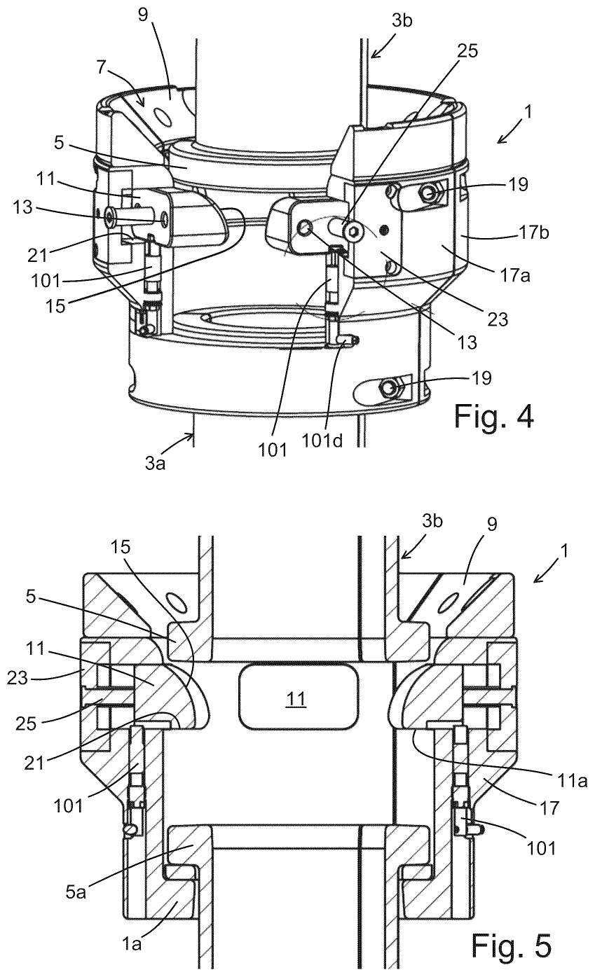

FIG. 4 is a perspective view of the bend restrictor clamp 1 with some parts cut away for illustrational purpose. As can also be seen in FIG. 1, the upper bend restrictor portion 3b has a shoulder 5 at its lower end. In the situation shown in FIG. 4, the shoulder 5 as entered a receiving aperture 7 of the bend restrictor clamp 1.

To assist alignment of the upper bend restrictor portion 3b with respect to the bend restrictor clamp 1, the receiving aperture 7 is provided with an inclined guide face 9. When engaging the bend restrictor clamp 1, the shoulder 5 will slide against the inclined guide face 9 such that it will become centrally aligned.

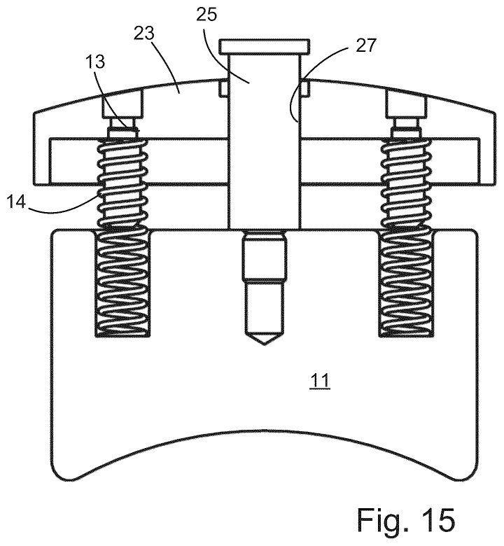

As the upper bend restrictor portion 3b is lowered further down, the shoulder 5 will abut against locking elements 11. The locking elements 11 are configured to be moved in a radial direction and are biased with one or more springs 14 (shown in FIG. 15) towards their radially inner position. The springs are supported at spring-receiving bores 13 arranged in the locking elements 11, indicated in FIG. 4.

The locking elements 11 have an inclined actuation face 15. As the shoulder 5 moves down it enters into engagement with the actuation faces 15 of the respective locking elements 11. This engagement moves the locking elements 11 radially outwards, against the biassing force from the springs 14.

The bend restrictor clamp 1 connects to the lower bend restrictor portion 3a with a connection flange 1a configured to transfer a pulling force to a pulling shoulder 5a of the lower bend restrictor portion 3a (cf. FIG. 5).

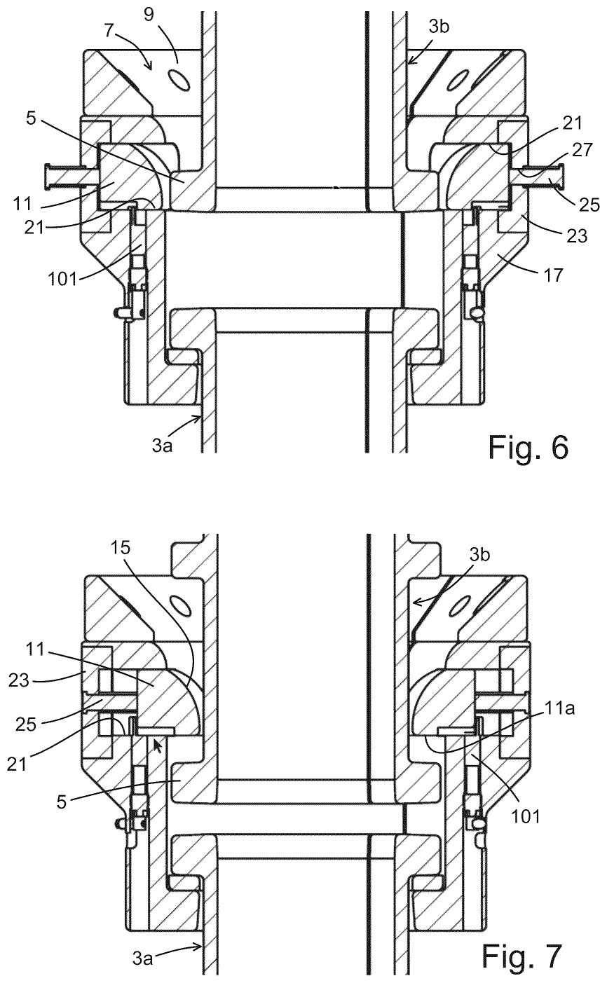

FIG. 6 depicts the situation where the locking elements 11 have been moved radially outwards by the engagement of the shoulder 5 against the inclined actuation faces 15.

The bend restrictor clamp 1 comprises a main body 17. In the shown embodiment, the main body 17 comprises a first main body part 17a and a second main body part 17b that are joined with a plurality of bolts 19 (cf. FIG. 4).

The locking elements 11 are supported inside element channels 21 that are arranged in the main body 17. Radially outside the respective element channels 21 there is arranged a channel lid 23. Furthermore, a pin 25 connects to the locking element 11 and extends through an aperture 27 in the channel lid 23.

The pin 25 thus functions as a guiding pin for the movement of the locking element 11. Moreover, since the pin 25 will extend out beyond the aperture 27 in the channel lid 23, it gives the operator a visual indication of the position of the locking element 11. This is shown in FIG. 6, where the pins 25 clearly extend out from and beyond the outer face of the channel lid 23.

As the upper bend restrictor portion 3b continues to be moved downwards, the shoulder 5 will move past the locking elements 11. This situation is shown in FIG. 7. Due to the inwardly biasing force from the springs 14, the locking elements 11 will then move back radially inwards. The upper bend restrictor portion 3b is then locked to the lower bend restrictor portion 3a, with the bend restrictor clamp 1.

The locking elements 11 comprise an abutment face 11a that will abut against the shoulder 5 if tension is applied between the lower and upper bend restrictor portions 3a, 3b.

The bend restrictor clamp 1 further comprises a locking arrangement 100. The locking arrangement 100 comprises a locking pin 101 which is visible in FIG. 4 to FIG. 7, which were discussed above.

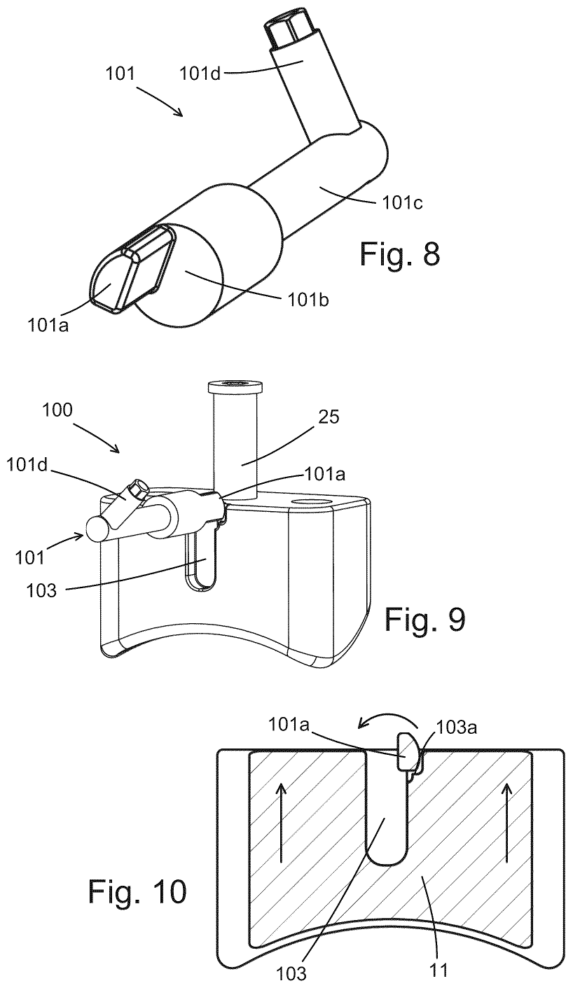

FIG. 8 depicts the locking pin 101 with a separate perspective view. FIG. 9 depicts the locking arrangement 100 with a separate view.

As shown in FIG. 9, the locking element 11 comprises a lock actuation slot 103. In the situation shown in FIG. 9, which is the same situation as shown in FIG. 4 and FIG. 5, a tip 101a of the locking pin 101a extends into the lock actuation slot 103.

This is schematically illustrated in FIG. 10. As the shoulder 5 of the upper bend restrictor portion 3b moves the locking element 11, the tip 101a collides with a rotation-inducing shoulder 103a of the lock actuation slot 103. The movement of the locking element 11 is an upward movement with respect to the view shown in FIG. 10.

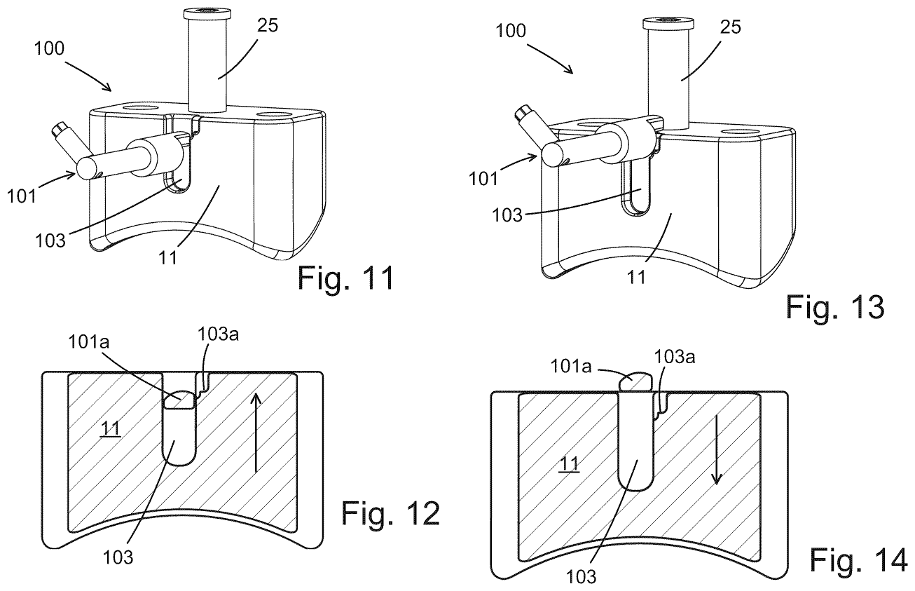

The engagement between the tip 101a and the rotation-inducing shoulder 103a makes the locking pin 101 rotate about a rotation axis, as indicated with the curved arrow. Due to this rotation, the tip 101a will now fit into the deeper part of the lock actuation slot 103. This is shown with the images shown in FIG. 11 and FIG. 12.

The locking element 11 continues its movement until the shoulder 5 has passed it, such that it moves back again (i.e., back down with respect to the images shown in FIG. 9 to FIG. 14). The locking pin 101 is spring-loaded towards the lock actuation slot 103 with a not-shown spring. Thus, due to the earlier rotation of the locking pin 101, when the locking element 11 moves back to its initial position, as shown in FIG. 9 and FIG. 10 (corresponding to the situation shown in FIG. 7), the tip 101a now moves out of the lock actuation slot 103.

This is shown in FIG. 13 and FIG. 14, wherein the locking pin 101 has moved a further distance towards the locking element 11, such that its tip 101a will prevent the locking element 11 from moving out of its position. In other words, the locking element 11 is locked in its locking position.

In this position, a locking pin shoulder 101b engages an end part of the lock actuation slot 103. The locking pin 101 extends beyond the lock actuation slot 103 with its tip 101a.

The locking pin 101 comprises a support stem 101c that engages with the main body 17 of the bend restrictor clamp 1, in such way that it can move along its axial direction. This can be seen e.g., in FIG. 4.

Furthermore, attached to the support stem 101c is an indication element 101d. The indication element 101d will be visible to the operator, such that the operator can see if the locking elements are in their locked state. In particular, compared to the initial position of the indication elements 101d, as shown in FIG. 4, FIG. 5, FIG. 9, and FIG. 10, the last position (i.e., the locking-indicating position) is both a displaced and a pivoted position.

FIG. 15 depicts a schematic view of one locking element 11, its pin 25, and its engagement with the channel lid 23. As discussed above, the locking element 11 can move with respect to the channel lid 23, while the pin 25 moves through the aperture 27 in the channel lid 23. Schematically shown in FIG. 15 are also a set of springs 14, which are received in the spring-receiving bore 13, which are arranged in the channel lid 23.

1. A bend restrictor clamp, the claim comprising:
a receiving aperture;
a plurality of movable locking elements; and
a plurality of springs biassing the locking elements towards a radially inner position;
wherein the respective locking elements comprise an inclined actuation face.

2. The bend restrictor clamp according to claim 1, further comprising a connection flange at the axial end of the bend restrictor clamp which is opposite the receiving aperture.

3. The bend restrictor clamp according to claim 1, wherein the locking elements are movably arranged in element channels and wherein the bend restrictor clamp further comprises channel lids at the radially outer end of the element channels.

4. The bend restrictor clamp according to claim 3, wherein the locking elements comprise a pin extending through an aperture in the channel lid, and wherein the pin extends beyond the outer surface of the channel lid when the locking element is in a radially outer position.

5. The bend restrictor clamp according to claim 1, wherein the locking elements further comprise a lock actuation slot, and wherein the bend restrictor clamp further comprises locking pins with a tip arranged in engagement with the lock actuation slot.

6. The bend restrictor clamp according to claim 5, wherein:
the lock actuation slot extends parallel to the direction of movement of the locking element and comprises a rotation-inducing shoulder;
the locking pin is supported in a rotatable manner, enabling rotation about a rotation axis;
the tip is offset from the rotation axis and in engagement with the rotation-inducing shoulder, such that upon a radially outwards movement of the locking element, the locking pin is rotated into a rotated position, out of engagement with the rotation-inducing shoulder and is moved further into the lock actuation slot.

7. The bend restrictor clamp according to claim 6, wherein the locking pin is biased against the lock actuation slot, in the direction of the rotation axis, and wherein when the locking element is in its radially inner position and when the locking pin is in its rotated position, the tip is in a locking position, out of the lock actuation slot.

8. The bend restrictor clamp according to claim 5, wherein the locking pins comprise an indication element.

9. The bend restrictor clamp according to claim 1, wherein the receiving aperture is provided with an inclined guide face.

10. The bend restrictor clamp according to claim 1, wherein it comprises a main body that has a first main body part and a second main body part that are joined with a plurality of bolts.
